(19) United States
(12) Patent Application Publication
(10) Pub. No.: US 2005/0254095 A1
(43) Pub. Date: Nov. 17, 2005

(54) Digital multifunctional imaging apparatus

(75) Inventor: Mikio Shoki, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/125,155

(22) Filed: May 10, 2005

(30) Foreign Application Priority Data
May 10, 2004 (JP) 2004-140430

(51) Int. Cl. H04N 1/405

(52) U.S. Cl. 358/3.03; 358/3.06; 358/1.13

(57) ABSTRACT

In a digital multifunctional apparatus, an image processing circuit which is configured by a hardware circuit compares a value of each image data of pixel with a predetermined threshold value so as to binarize the value of such image data, and calculates an error component, and further adds a product obtained by multiplying the error component and predetermined coefficient to an initial values of the image data of each pixel. By sequentially performing such binarization and addition with respect to each pixel, it is possible that while reading the image data of a document, the image processing circuit quickly performs the quasi-halftone processing to the image data without increasing burden of a CPU. Thus, the quasi-halftone processing can be achieved using an inexpensive CPU without using a DSP and expensive CPUs having high operating clock frequencies, thereby reducing cost of the digital multifunctional apparatus.

### BACKGROUND OF THE INVENTION

1. Field of the Invention

The present invention relates to a digital multifunctional imaging apparatus (hereafter referred to simply as “digital multifunctional apparatus”) which has a printing function and a scanning function, and is capable of copying a document independently without being connected to an apparatus having a host function such as a personal computer.

2. Description of the Related Art

A digital multifunctional apparatus has an image processing function for enlarging/reducing image data read by an image sensor (scanner unit) in order to adjust the image data to, for example, a size of a printing paper. When a host apparatus such as a personal computer is connected to the digital multifunctional apparatus, such image processing can easily be performed with using a CPU (Central Processing Unit) in the host apparatus. On the other hand, in a digital multifunctional apparatus of called stand-alone type that can copy a document independently, three CPUs are used for scan control, print control and entire control of the digital multifunctional apparatus, respectively, while one DSP (Digital Signal Processor) is used for image processing, in order to perform the copy process without being connected to a host apparatus, or without starting up the host apparatus.

In such an imaging apparatus, when an image is formed directly with using an image data read by the image sensor, it will be a hard image having a high contrast. For obtaining a halftone image, data processing such as average error minimization is conventionally performed to the image data read by the image sensor (refer to, for example, Japanese Laid-open Patent Publications Sho 58-215169 and Sho 61-52073).

However, the above-mentioned conventional digital multifunctional apparatus is configured to perform the image processing through a firmware using the DSP, so that the processing speed depends on the operating frequencies of the CPUs and the DSP in the digital multifunctional apparatus, in which the DSP operates in synchronization with the CPUs. Thus, in order to complete the image processing and start printing operation in a short time, it is necessary to increase the frequencies of the operating clock of the CPUs and the DSP in the digital multifunctional apparatus. For example, the frequency of the operating clock of the three CPUs is required to be about 100 MHz, while the frequency of the operating clock of the DSP is required to be about 200 MHz. Accordingly, it is needed to use many such CPUs and DSP, which are expensive and thus remain an obstacle to cost reduction of the digital multifunctional apparatus. This problem cannot be solved by using the technology disclosed in either one of the above patent publications.

### SUMMARY OF THE INVENTION

An object of the present invention is to provide such a digital multifunctional apparatus that can perform a quasi-halftone processing to image data read by an image sensor for printing without using CPUs and a DSP having high frequencies of operating clock so as to achieve cost reduction.

A digital multifunctional imaging apparatus capable of copying a document independently in accordance with an aspect of the present invention comprises: an image sensor for irradiating light onto a document and receiving light reflected from the document so as to read image data of the document; an image processor for performing quasi-halftone processing to image data read by the image sensor; a buffer for temporarily memorizing the image data to which the quasi-halftone processing is performed by the image processor; a printing mechanism for printing an image with using the image data memorized in the buffer; a CPU (Central Processing Unit) for controlling the image sensor, the image processor, the buffer and the printing mechanism; and a memory memorizing operating programs of the CPU.

The image processor is configured by a hardware circuit. While reading the image data of the document, the image processor performs the quasi-halftone processing to the image data for printing without increasing burden of the control means.

According to the first aspect of the present invention, the image processor is configured by a hardware circuit, so that it is possible that while reading the image data of a document, the image processor quickly performs the quasi-halftone processing to the image data without increasing the burden of the CPU. Thus, it is possible to use, an inexpensive CPU having a low operating clock frequency, while reducing time required from reading of the document to printing, thereby making it possible to reduce the cost of the digital multifunctional apparatus. Furthermore, an error component generated in binarizing image data of each pixel is diffused to neighboring pixels, so that printing of more accurate and natural halftone becomes possible. Besides, the setting of the halftone characteristics of the digital multifunctional apparatus, such as increasing or reducing the sharpness of edges in an image, can be easily varied by appropriately varying the coefficients to multiply the error component of each pixel currently in the binarization process.

### BRIEF DESCRIPTION OF THE DRAWINGS

FIG. 1 is a block diagram showing a configuration of a digital multifunctional apparatus in accordance with an embodiment of the present invention;

FIG. 2 is a chart schematically showing pixels in quasi-halftone processing according to the multifunctional apparatus;

FIG. 3 is a chart schematically showing coefficients of a filter used for quasi-halftone processing in the multifunctional apparatus; and

FIG. 4 is a chart schematically showing a flow of an error diffusion process according to an image processing circuit of the multifunctional apparatus.

### DESCRIPTION OF THE PREFERRED EMBODIMENTS

A preferred embodiment in accordance with the present invention will be described with reference to the drawings.

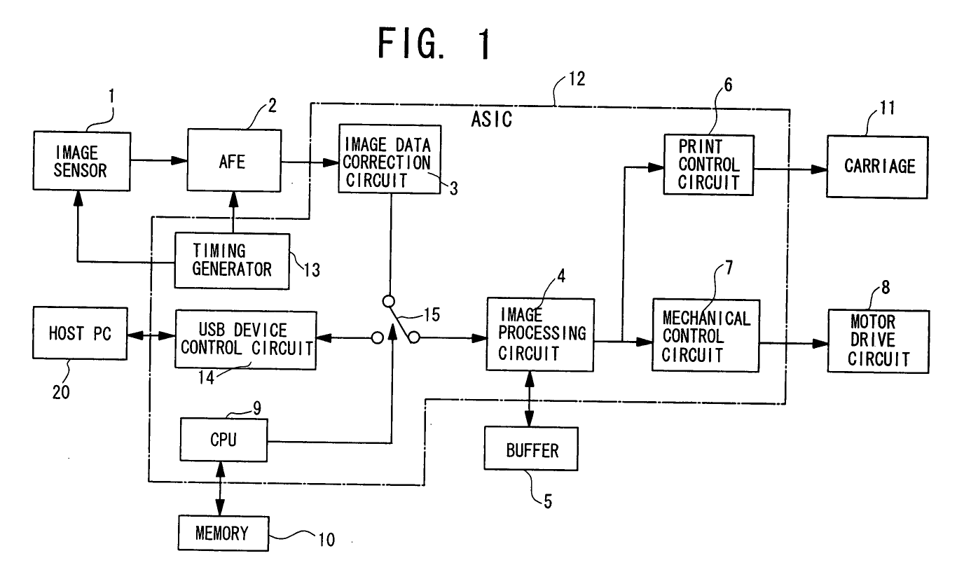

FIG. 1 shows a schematic block diagram of a digital multifunctional apparatus having an inkjet printer mechanism in accordance with the embodiment. The digital multifunctional apparatus comprises: an image sensor 1 for reading image data of a document and converting the read image data into analog electric signals; an analog front-end circuit (AFE) 2 for converting the analog electric signals of the image data read by the image sensor 1 into digital electric signals; an image data correction circuit 3 for correcting the image data output from the AFE 2, if necessary; an image processing circuit (serving as an image processing means) 4 for enlarging/reducing the image data output from the image data correction circuit 3; a buffer (serving as a buffer means) 5 for temporarily memorizing the image data processed by the image processing circuit 4; a print control circuit 6 for controlling motion of a carriage 11 on the basis of the image data memorized in the buffer 5; a mechanical control circuit 7 for mechanically controlling a paper feed motor (not shown), and so on; a motor drive circuit 8 for applying a drive voltage to the paper feed motor, and so on, on the basis of control signals output from the mechanical control circuit 7; a CPU (Central Processing Unit, serving as a control means) 9 for controlling respective elements in the digital multifunctional apparatus; a memory (serving as a memory means) 10 memorizing operating programs of the CPU 9 and various data required for the operation of the CPU 9; a carriage (serving as a printing means) 11 for printing a print based on the image data memorized in the buffer 5; and so on. The CPU 9 controls not only the respective elements as described above such as the image sensor 1, the image processing circuit 4 and the buffer 5, but also other elements such as the print carriage 11.

The above-mentioned image data correction circuit 3, the image processing circuit 4, the print control circuit 6, the mechanical control circuit 7 and the CPU 9 are integrated into one-chip ASIC (Application-Specific Integrated Circuit) 12. Note that the CPU 9 used in this embodiment has an operating clock frequency of 48 MHz. The ASIC 12 further has, integrated therein, a timing generator 13 for outputting synchronizing signals to the image sensor 1 and the AFE 2, and also has a USB (Universal Serial Bus) device control circuit 14 which is connected via a USB cable to a host PC (personal computer) 20 to be connected to the digital multifunctional apparatus, and which functions as an interface to the host PC 20.

The image sensor 1 is configured by a CCD (Charge Coupled Device) or a CIS (Contact Image Sensor) each having pixels aligned in a row, and so on. The image sensor 1 irradiates light onto a document, receives light reflected from the document so as to read image data for each line (for example, 5100 pixels), and converts the image data into electric signals. The image data correction circuit 3 performs black level calibration for the image data output from the AFE 2, sensitivity correction for each pixel as well as level correction and gamma correction for each color of RGB (Red, Green and Blue). The image data corrected by the image data correction circuit 3 are output to alternative of the image processing circuit 4 and the USB device control circuit 14 via a switch 15, switching operation of which is controlled by the CPU 9. More specifically, when the switch 15 is turned to the image processing circuit 4, the digital multifunctional apparatus can copy the image data of the document independently. On the other hand, when the switch 15 is turned to the USB device control circuit 14, the image data output from the image data correction circuit 3 are transferred via the USB device control circuit 14 to the host PC 20.

The image processing circuit 4 is configured by a hardware circuit (logic circuit), and performs the quasi-halftone processing to the image data output from the image data correction circuit 3. The image data performed by the image processing circuit 4 is temporarily memorized in the buffer 5′.

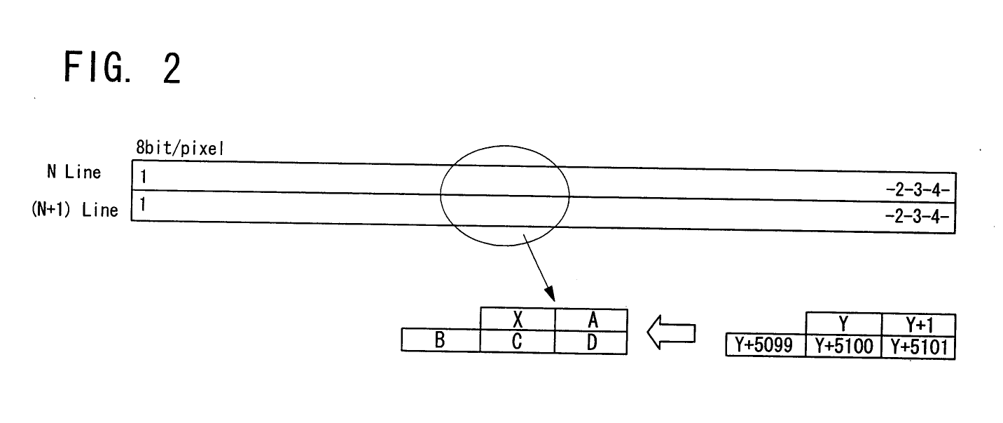

FIG. 2 shows pixels in the quasi-halftone processing, using a 2×3 (2 row×3 column) filter. Attending to pixels on a line having a number N and a line having a number N+1, the image processing circuit 4 diffuses error component generated in the binarization process of a pixel designated by a symbol X (hereinafter abbreviated as pixel X) which is currently in the binarization process to neighboring pixels designated by symbols A, B, C and D (hereinafter abbreviated as pixels A, B, C and D). At this time, a ring buffer which is formed in the buffer 5 and can memorize data for 3 lines, is used for memorizing image data in such image processing. The image data of the pixel X is memorized at an address designated by a symbol Y. Similarly, the image data of the pixels A, B, C and D are respectively memorized, for example, at address designated by symbols Y+1, Y+5099, Y+5100 and Y+5101. Each image data is configured by color components of cyan, magenta and yellow.

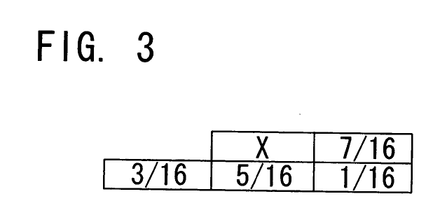

FIG. 3 schematically shows a 2×3 (Floyd Steinberg) coefficients of a filter which the image processing circuit 4 uses for diffusing the error component generated in the binarization process for the pixel X to the neighboring pixels A, B, C and D. The values shown in boxes corresponding to the pixels A, B, C and D respectively designate coefficients to multiply the error component. For example, with respect to the pixel A, the error component generated in the binarization process for the pixel X is diffused to the pixel A in a manner so that a numeric value obtained by multiplication of the error component generated in the binarization process for the pixel X and a coefficient (= 7/16) is added to the value of the image data of the pixel A. The generated error component is also diffused to the pixels B, C and D in a similar manner.

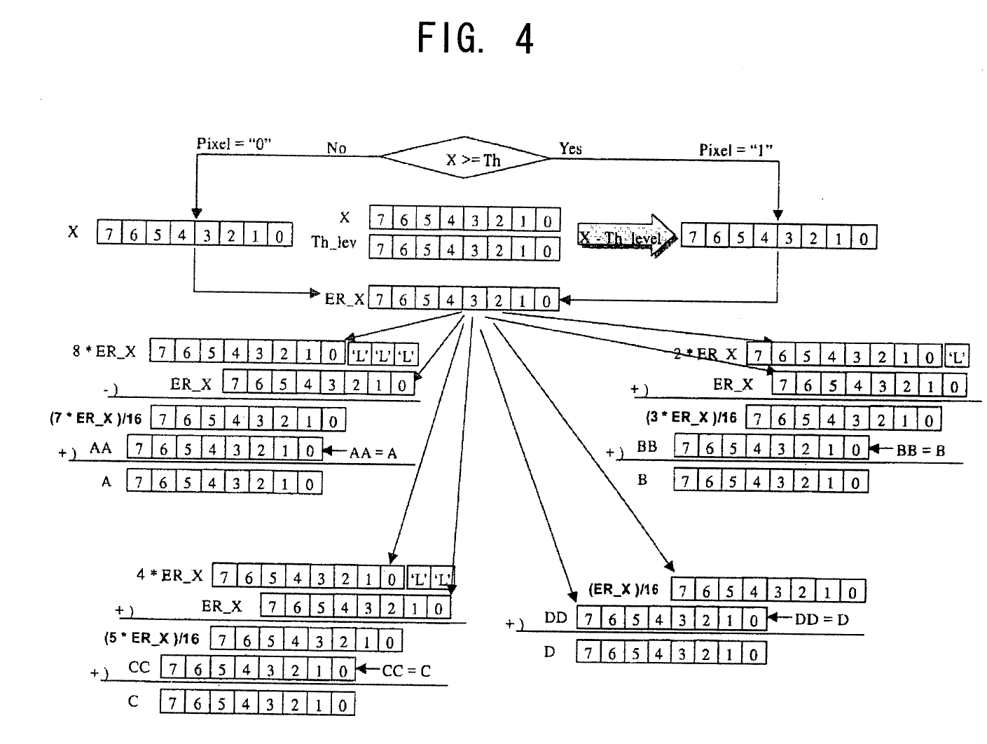

Subsequently, a flow of the error diffusion process according to the image processing circuit 4 will be described below with reference to FIG. 4. The image processing circuit 4 compares the value of the image data of pixel X with a predetermined threshold value Th. When the value of the image data of the pixel X is equal to or larger than the threshold value Th, the image processing circuit 4 regards that the value of the image data of the pixel X is “1”, and calculates an error component ER_X, which corresponds a value subtracted “1” from the value of the image data of the pixel X. Alternatively, when the value of the image data of the pixel X is smaller than the threshold value Th, the image processing circuit 4 regards that the value of the image data of the pixel X is “0”. In the latter case, the value itself of the image data of the pixel X corresponds to the error component ER_X. Subsequently, for example, with respect to the pixel A, the error component generated in the binarization process for the pixel X is diffused to the pixel A in a manner so that the numeric value obtained by multiplication of the error component ER_X and the coefficient (= 7/16) is added to the initial value AA of the image data of the pixel A. Further, the error component ER_X of the pixel X is diffused to the pixels B, C and D by similar calculations, using the shown coefficients (= 3/16, 5/16 and 1/16), respectively, and adding similarly calculated values to initial values BB, CC and DD of the image data of the pixels B, C and D. By repeating these processes to each pixel for each color component, the binarization process for all the pixels for the quasi-halftone processing is ultimately completed. Note that the binarized image data are memorized in 8 bit unit or 16 bit unit at a separate address in the ring buffer.

As mentioned above, according to the digital multifunctional apparatus in this embodiment, since the image processing circuit 4 is configured by a hardware circuit, it is possible that while reading the image data of a document, the image processing circuit 4 quickly performs quasi-halftone processing to the read image data without increasing the burden of the CPU 9. Thus, it is possible to use an inexpensive processor having a low operating clock frequency for the CPU 9, while reducing time required from reading of a document to printing, thereby making it possible to reduce the cost of the digital multifunctional apparatus. Furthermore, the control means for controlling the digital multifunctional apparatus of the present embodiment is formed of one CPU, and it is possible to omit a CPU for scan control, a CPU for print control and a DSP for image processing, so that the cost of the digital multifunctional apparatus can be further reduced.

Thus, according to the present embodiment, the image processing circuit 4 compares a value of image data of a pixel read by the image sensor 1 with a predetermined threshold value to binarize the value of the image data, and repeats the binarization process for all pixels so as to sequentially binarize values of the image data of all the pixels. The image processing circuit 4 multiplies an error component in a pixel currently in the binarization process by predetermined coefficients to obtain products, and adds the products to image data of neighboring pixels, respectively, so as to diffuse the error component generated in the binarization process for the pixel to the neighboring pixels and to calculate values of the images data of the neighboring pixels, and further repeats the diffusion and calculation process for all the pixels so as to sequentially diffuse and calculate values of the image data of all the pixels. The image data thus binarized for pseudo halftone processing are stored in the buffer 5, and are used for printing.

In addition, according to the present embodiment, an error component generated in binarizing image data of each pixel is diffused to neighboring pixels, so that printing of more accurate and natural halftone becomes possible. Besides, the setting of the halftone characteristics of the digital multifunctional apparatus, such as increasing or reducing the sharpness of edges in an image, can be easily varied by appropriately varying the coefficients to multiply an error component of each pixel currently in the binarization process.

It is to be noted that the present invention is not limited to the structure, configuration or process of the above embodiment, and various modifications are possible. For example, the configuration of the image processing circuit 4 is not limited to that shown in FIG. 4, but can be a hardware circuit for another quasi-halftone processing algorithm, such as a hardware circuit corresponding to a 2×3 filter having other coefficients different from those described above or 3×5 filter (Jarvis-Judice-Ninke filter or Stucki filter). In addition, the printer function is not limited to an inkjet printer, but can be a laser printer.

This application is based on Japanese patent application 2004-140430 filed May 10, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A digital multifunctional imaging apparatus capable of copying a document independently, comprising:
an image sensor for irradiating light onto a document and receiving light reflected from the document so as to read image data of the document;
an image processor for performing quasi-halftone processing to image data read by the image sensor;
a buffer for temporarily memorizing the image data to which the quasi-halftone processing is performed by the image processor;
a printing mechanism for printing an image with using the image data memorized in the buffer;
a CPU (Central Processing Unit) for controlling the image sensor, the image processor, the buffer and the printing mechanism; and
a memory memorizing operating programs of the CPU, wherein
the image processor is configured by a hardware circuit; and
while reading the image data of the document, the image processor performs the quasi-halftone processing to the image data for printing without increasing burden of the control means.

2. The digital multifunctional imaging apparatus in accordance with claim 1, wherein
the image processor performs filtering processing to the image data of each pixel read by the image sensor with using a matrix of predetermined coefficients, so as to perform the quasi-halftone processing to the image data.

3. A digital multifunctional imaging device capable of copying a document independently, comprising:
an image sensor for irradiating light onto a document and receiving light reflected from the document so as to read image data of the document;
an image processing means for performing quasi-halftone processing to image data read by the image sensor;
a buffer means for temporarily storing the image data to which the quasi-halftone processing is performed by the image processing means;
a printing means for printing an image with using the image data stored in the buffer means;
a control means for controlling the image sensor, the image processing means, the buffer means and the printing means; and
a memory means memorizing operating programs of the control means, wherein
the control means is configured by a single CPU (Central Processing Unit),
the image processing means is formed of a hardware circuit,
the image processing means compares a value of image data of each pixel read by the image sensor with a predetermined threshold value so as to sequentially binarize values of the image data of respective pixels, and
the image processing means further multiplies an error component in each pixel currently in the binarization process by predetermined coefficients to obtain products and adds the products to image data of neighboring pixels, respectively, so as to diffuse the error component generated in the binarization process for the each pixel to the neighboring pixels and to sequentially calculate values of the images data of the respective pixels, the binarized image data being stored in the buffer means,
whereby while reading the image data of the document, the image processing means subjects the read image data to the quasi-halftone processing for printing without increasing burden of the control means.
